(19) United States
(12) Patent Application Publication
(10) Pub. No.: US 2022/0027098 A1
(43) Pub. Date: Jan. 27, 2022

(54) IMAGE FORMING APPARATUS, METHOD FOR CONTROLLING THE SAME, AND STORAGE MEDIUM

(71) Applicant: CANON KABUSHIKI KAISHA, Tokyo (JP)

(72) Inventor: Takaaki Miyata, Ibaraki (JP)

(21) Appl. No.: 17/380,672

(22) Filed: Jul. 20, 2021

(30) Foreign Application Priority Data
Jul. 27, 2020 (JP) 2020-126643

(51) Int. Cl. G06F 3/12

(52) U.S. Cl. CPC G06F 3/1205; G06F 3/1271; G06F 3/121; G06F 3/1288

(57) ABSTRACT

An image forming apparatus includes a registration unit configured to register an address at which image data to be printed is stored, an acquisition unit configured to access the registered address to acquire the image data, a control unit configured to perform print processing based on the acquired image data, a first setting unit configured to set a number of copies to be printed when printing based on the acquired image data is performed in response to an instruction received from a user through an operation unit, a reception unit configured to receive a specified time of day, and a second setting unit configured to set a number of copies to be printed when the printing based on the acquired image data is performed upon arrival of the time received by the reception unit.

### BACKGROUND

### Field of the Disclosure

The present disclosure relates to an image forming apparatus, a method for controlling the image forming apparatus, and a storage medium.

### Description of the Related Art

In recent years, image forming apparatuses that can operate an optional application on firmware have increased. These apparatuses are implemented by having an execution environment for executing the application and by executing the application in the execution environment.

As such an application, there is known an application that associates a button displayed on an operation screen with access information allowing acquisition of data and with print settings. When the button on the operation screen is pressed, the above-described application acquires the data using the access information associated with the button, and performs printing based on the set print settings. Furthermore, the application allows the user to set a schedule for performing printing at a specified time on a specified day of the week. If such settings are made, when the specified time on the specified day of the week arrives, an effect similar to that obtained when the button is pressed can be obtained (refer to Japanese Patent Application Laid-Open No. 2017-148978).

However, in the case of the schedule settings discussed in Japanese Patent Application Laid-Open No. 2017-148978, when the specified time on the specified day of the week arrives, print settings similar to those applied when the button is pressed are applied. More specifically, in order to print different numbers of copies when performing printing in response to the pressing of the button and when performing printing upon the arrival of the specified time on the specified day of the week, it is necessary to register the different numbers of copies in association with different buttons.

### SUMMARY

According to embodiments of the present disclosure, an image forming apparatus includes a registration unit configured to register an address at which image data to be printed is stored, an acquisition unit configured to access the registered address to acquire the image data, a control unit configured to perform print processing based on the acquired image data, a first setting unit configured to set a number of copies to be printed when printing based on the acquired image data is performed in response to an instruction received from a user through an operation unit, a reception unit configured to receive a specified time of day, and a second setting unit configured to set a number of copies to be printed when the printing based on the acquired image data is performed upon arrival of the time received by the reception unit.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of a main portion of an image forming apparatus according to an exemplary embodiment of the present disclosure.

FIG. 2 is a block diagram illustrating examples of execution environments of extension applications of the image forming apparatus according to the exemplary embodiment of the present disclosure.

FIG. 3 is a diagram illustrating a configuration of software modules that operate on a central processing unit (CPU) of the image forming apparatus according to the exemplary embodiment of the present disclosure.

FIG. 4 is a diagram illustrating an example of a device configuration of a printing system including the image forming apparatus according to the exemplary embodiment of the present disclosure at the time of installation of the extension application.

FIG. 5 is a diagram illustrating a flow of a procedure for installing installation data of the extension application stored in a host personal computer (PC) onto the image forming apparatus, according to the exemplary embodiment of the present disclosure.

FIG. 6A is a diagram illustrating an example of a setting screen for the extension application according to the exemplary embodiment of the present disclosure. FIG. 6B is a diagram illustrating another example of the setting screen for the extension application according to the exemplary embodiment of the present disclosure.

FIG. 7 is a diagram illustrating a flow of an application setting procedure according to the exemplary embodiment of the present disclosure.

FIG. 8A is a diagram illustrating an example of setting data of the extension application according to the exemplary embodiment of the present disclosure. FIG. 8B is a diagram illustrating another example of the setting data of the extension application according to the exemplary embodiment of the present disclosure.

FIG. 9 is a diagram illustrating a flow of a procedure for executing an application when an icon for the application is pressed, according to the exemplary embodiment of the present disclosure.

FIG. 10 is a diagram illustrating a structure of the installation data of the extension application according to the exemplary embodiment of the present disclosure.

FIG. 11 is a diagram illustrating how to process each page when printing a multi-page document, according to the exemplary embodiment of the present disclosure.

FIG. 12 is a diagram illustrating an example of a screen displayed while a content printing application is being executed, according to the exemplary embodiment of the present disclosure.

FIG. 13 is a diagram illustrating an example of a screen displayed while pause processing is in progress after a pause button is pressed, according to the exemplary embodiment of the present disclosure.

FIG. 14 is a diagram illustrating how to process each page when printing two files in a folder, according to the exemplary embodiment of the present disclosure.

FIG. 15 is a flowchart illustrating details of setting information registration processing in the application setting procedure, according to the exemplary embodiment of the present disclosure.

FIG. 16 is a diagram illustrating an example of a warning message popped up on the setting screen, according to the exemplary embodiment of the present disclosure.

### DESCRIPTION OF THE EMBODIMENTS

Exemplary embodiments of the present disclosure will be described below with reference to the attached drawings.

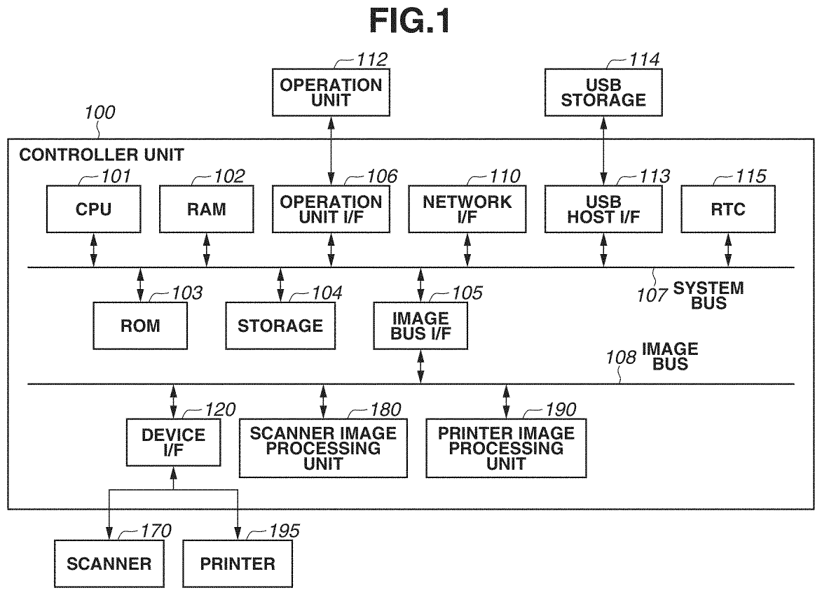

FIG. 1 is a block diagram illustrating an example of a configuration of a main portion of an image forming apparatus according to an exemplary embodiment of the present disclosure. The image forming apparatus according to the present exemplary embodiment includes a controller unit 100. A scanner 170 serving as an image input device, and a printer 195 serving as an image output device are connected to the controller unit 100. An operation unit 112 is also connected to the controller unit 100. The controller unit 100 performs control to implement a copy function in which the printer 195 prints and outputs image data read by the scanner 170.

The controller unit 100 includes a central processing unit (CPU) 101. The CPU 101 starts up an operating system (OS) using a boot program stored in a read-only memory (ROM) 103. The CPU 101 executes on the OS a program stored in a storage 104, thereby performing various types of processing. A random-access memory (RAM) 102 is used as a work area for the CPU 101. The RAM 102 provides the work area and also provides an image memory area for temporarily storing image data. The storage 104 stores a program, image data, and information about sheet feeding capacity including the maximum number of sheets to be fed by the image forming apparatus.

The CPU 101 is connected to the other modules via a system bus 107. An operation unit interface (I/F) 106 is an interface with the operation unit 112 including a touch panel, and outputs to the operation unit 112 image data to be displayed on the operation unit 112. The operation unit I/F 106 transmits information input by a user through the operation unit 112 to the CPU 101. A network I/F 110 connects the image forming apparatus to a local area network (LAN).

A Universal Serial Bus (USB) host I/F 113 is an interface unit that communicates with a USB storage 114. The USB host I/F 113 is an output unit for storing, in the USB storage 114, data stored in the storage 104. The USB host I/F 113 inputs the data stored in the USB storage 114 to the controller unit 100 and notifies the CPU 101 of the input of the data. The USB storage 114 is an external storage device that stores data, and is detachably attached to the USB host I/F 113. A plurality of USB devices including the USB storage 114 can be connected to the USB host I/F 113.

A real-time clock (RTC) 115 controls the current time. Information about the time controlled by the RTC 115 is used, for example, to record a job submission time.

An image bus I/F 105 is a bus bridge for connecting the system bus 107 and an image bus 108 that transfers image data at a high speed, and converting the data format of the image data. The image bus 108 is composed of a Peripheral Component Interconnect (PCI) bus or an Institute of Electrical and Electronics Engineers (IEEE) 1394 bus. On the image bus 108, a device I/F 120, a scanner image processing unit 180, and a printer image processing unit 190 are provided. The scanner 170 and the printer 195 are connected to the device I/F 120. The device I/F 120 performs synchronous-to-asynchronous or asynchronous-to-synchronous conversion of image data. The scanner image processing unit 180 corrects, processes, and edits input image data. The printer image processing unit 190 corrects print output image data and converts the resolution of the print output image data, depending on the printer 195.

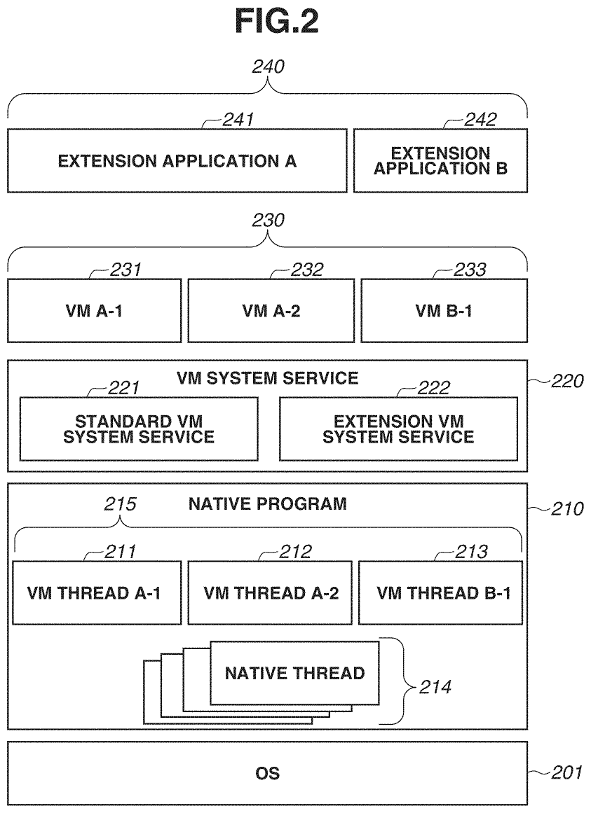

FIG. 2 is a block diagram illustrating examples of execution environments of extension applications 240 (extension application A 241 and extension application B 242) of the image forming apparatus. Modules illustrated in FIG. 2 are implemented by the CPU 101 loading a program stored in the storage 104 into the RAM 102 and executing the program. A native program 210 for controlling image processing units, such as the printer 195, a facsimile (fax), and the scanner 170, operates on an OS 201. Virtual machines (VMs) 230 (VM A-1 231, VM A-2 232, and VM B-1 233) as the execution environments of the extension applications 240 also operate on the OS 201. The VMs 230 are modules that understand and execute programs for controlling the extension applications 240. The extension applications 240 always operate on the VMs 230. The programs operating on the VMs 230 operate according to commands dedicated to the VMs 230, unlike those operating on the CPU 101. The commands dedicated to the VMs 230 are referred to as “bytecodes”. On the other hand, the command dedicated to the CPU 101 is referred to as a “native code”. The VMs 230 sequentially interpret and process the bytecodes, whereby the native code and the bytecodes of the VMs 230 operate on the CPU 101. The types of the VMs 230 include a type that sequentially interprets and processes the bytecodes without conversion, and a type that converts the bytecode into the native code and executes the native code. The VMs 230 according to the present exemplary embodiment are of the former type, but may be of the latter type. Generally, commands that operate on different types of CPUs are incompatible with each other. Similarly, commands that operate on different VMs are also incompatible with each other. The VMs 230 according to the present exemplary embodiment are software modules that operate on the CPU 101, but may be hardware modules.

The native program 210 includes native threads 214 for controlling the image processing units such as the printer 195, the fax, and the scanner 170, and VM threads 215 for running the VMs 230. There are as many VM threads as the number of VMs 230. In this example, three VM threads (VM thread A-1 211, VM thread A-2 212, and VM thread B-1 213) are generated.

A VM system service 220 is a utility library shared by the extension applications 240. The extension applications 240 call the function of the VM system service 220, whereby it is possible to save the trouble of developing the extension applications 240 or to access the modules of the image forming apparatus. The VM system service 220 includes a standard VM system service 221 that minimally operates as a VM, and an extension VM system service 222 that provides the function of accessing the modules of the image forming apparatus, and the function of an OS. The VM system service 220 also has the function of loading the extension applications 240. The VMs 230 execute an application programming interface (API) specified by bytecodes in the extension applications 240, thereby calling the VM system service 220 associated with the API.

The VMs 230 execute the extension applications 240. The VMs 230 are each generated for each thread of the extension applications 240. In the example of FIG. 2, the VM A-1 231 and the VM A-2 232 for running two threads in the extension application A 241, and the VM B-1 233 for running a single thread in the extension application B 242 are generated.

On a main menu screen displayed on the operation unit 112 of the image forming apparatus, respective icons corresponding to the extension applications 240 are displayed. If the operation unit I/F 106 detects, through the operation unit 112, that any of the icons is selected by the user, the operation unit I/F 106 transmits to the CPU 101 a notification that the icon is selected by the user. The CPU 101 having received the notification starts up the extension application 240 corresponding to the icon selected by the user.

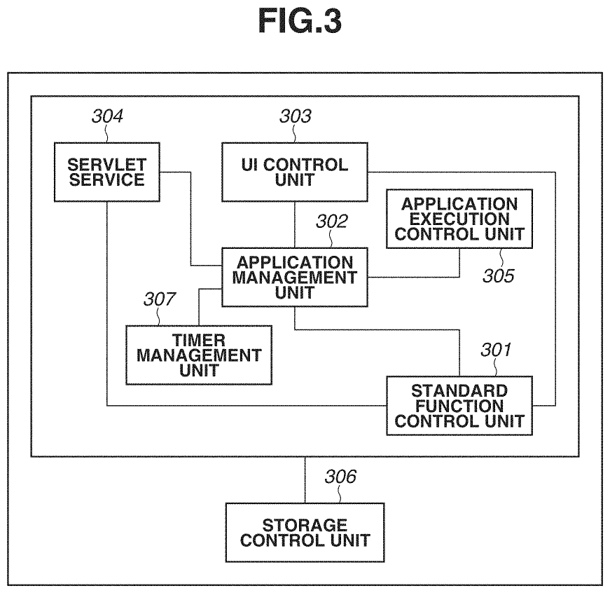

FIG. 3 illustrates a configuration of software modules that operate on the CPU 101 of the image forming apparatus according to the present exemplary embodiment. A servlet service 304 is a module that assigns processing to a relevant module based on a Uniform Resource Locator (URL) accessed upon receipt of the request in the case of Hypertext Transfer Protocol (HTTP) access through the network I/F 110. A user interface (UI) control unit 303 is a module that displays a screen on the operation unit 112, receives an operation from the user on the screen, and notifies a relevant module (an application management unit 302 or a standard function control unit 301) of operation information about the received operation. The application management unit 302 is a module that manages the installation and start-up of the extension applications 240. An application execution control unit 305 is a module that controls the execution of the extension applications 240 started up by the application management unit 302. More specifically, the application execution control unit 305 controls the VM threads 215, the VM system service 220, the VMs 230, and the extension applications 240. A storage control unit 306 is a module that records and manages programs for the extension applications 240 and setting information of the extension applications 240. The application execution control unit 305 accesses the storage control unit 306 to read an application program. Each of the modules accesses the storage control unit 306 to refer to or set setting values. The standard function control unit 301 is a module that performs control of a copy function and a fax function, which are standard functions of the image forming apparatus, and other types of control (e.g., control of the USB host I/F 113) required for the image forming apparatus. A timer management unit 307 acquires current time information from the RTC 115, detects the arrival of a predetermined time, and notifies the application management unit 302 of the arrival. The application management unit 302 receives the notification from the timer management unit 307 and requests the application execution control unit 305 to perform application timer processing.

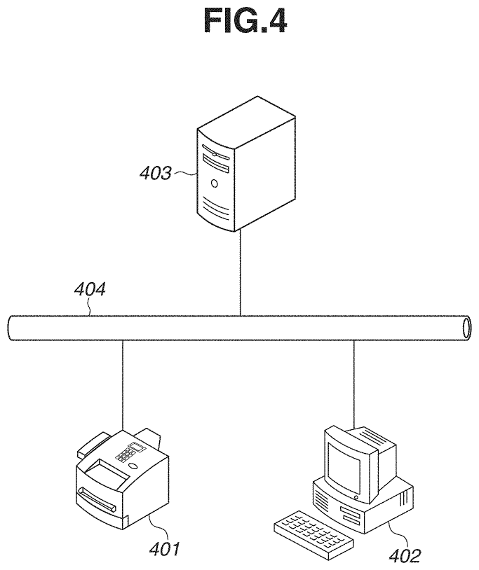

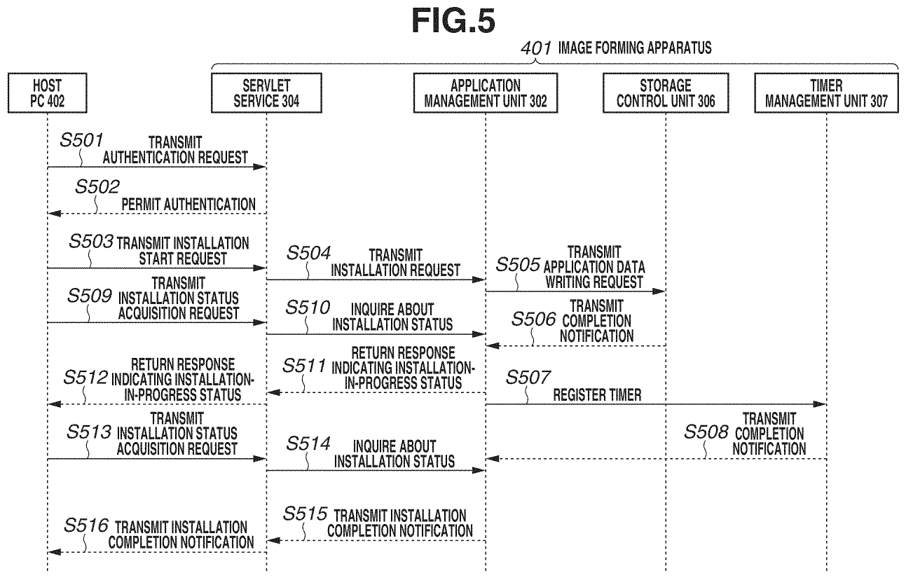

FIG. 4 illustrates an example of a device configuration of a printing system including an image forming apparatus 401 as the image forming apparatus according to the present exemplary embodiment at the time of installation of any of the extension applications 240. The printing system includes the image forming apparatus 401, a host personal computer (PC) 402, a server 403, and Ethernet 404.

The image forming apparatus 401 provides a method for installing the extension application 240, to the host PC 402 via the Ethernet 404. The host PC 402, which stores installation data of the extension application 240, installs the extension application 240 onto the image forming apparatus 401 using the method for installing the extension application 240, which is provided by the image forming apparatus 401. The server 403, which stores image data to be printed, transmits the image data to the image forming apparatus 401 in response to an image data acquisition request from the image forming apparatus 401.

FIG. 5 illustrates a flow of a procedure for installing the installation data of the extension application 240, which is stored in the host PC 402, onto the image forming apparatus 401. The procedure is performed by the CPU 101. First, in step S501, the host PC 402 transmits an authentication request for installing the installation data onto the image forming apparatus 401. At this time, the host PC 402 notifies the image forming apparatus 401 of information (a user identification (ID) and a password) required for the authentication. In step S502, the servlet service 304 having received the authentication request checks the authentication information. If there is no problem with the authentication information, the servlet service 304 returns an authentication permission response. At this time, the servlet service 304 returns the response with a character string (a token) indicating the permission of the authentication request. In step S503, the host PC 402 having received the authentication permission response transmits an installation start request to the image forming apparatus 401. At this time, the host PC 402 notifies the image forming apparatus 401 of the installation data of the extension application 240 stored in the host PC 402 and the token acquired in step S502. In step S504, the servlet service 304 having received the installation start request confirms whether the token is correct. If there is no problem with the token, the servlet service 304 transmits, to the application management unit 302, an installation request for installing the extension application 240. In step S505, the application management unit 302 having received the installation request transmits an application data writing request to the storage control unit 306. The storage control unit 306 having received the application data writing request writes the installation data to the storage 104. After completion of the writing, in step S506, the storage control unit 306 notifies the application management unit 302 of the completion of the writing. In step S507, the application management unit 302 registers, in the timer management unit 307, timer information included in the installation data. In step S508, the timer management unit 307 notifies the application management unit 302 of the completion of the timer. The timer information will be described below. In step S509, the host PC 402 transmits an installation status acquisition request to the image forming apparatus 401. At this time, the host PC 402 notifies the image forming apparatus 401 of the token acquired in step S502. In step S509, the servlet service 304 having received the installation status acquisition request confirms whether the token is correct. If there is no problem with the token, then in step S510, the servlet service 304 inquires of the application management unit 302 about the installation status. The application management unit 302 having received the inquiry about the installation status returns a response indicating the current installation status. At this time, the extension application 240 is being installed. Thus, in step S511, the application management unit 302 returns a response indicating an installation-in-progress status. In step S512, the servlet service 304 notifies the host PC 402 of the status acquired from the application management unit 302. In steps S513 to S516, the host PC 402 checks the installation status again. At this time, the installation is completed and thus the host PC 402 is notified of the completion of the installation.

By the above processing, the installation data of the extension application 240 stored in the host PC 402 is installed onto the image forming apparatus 401.

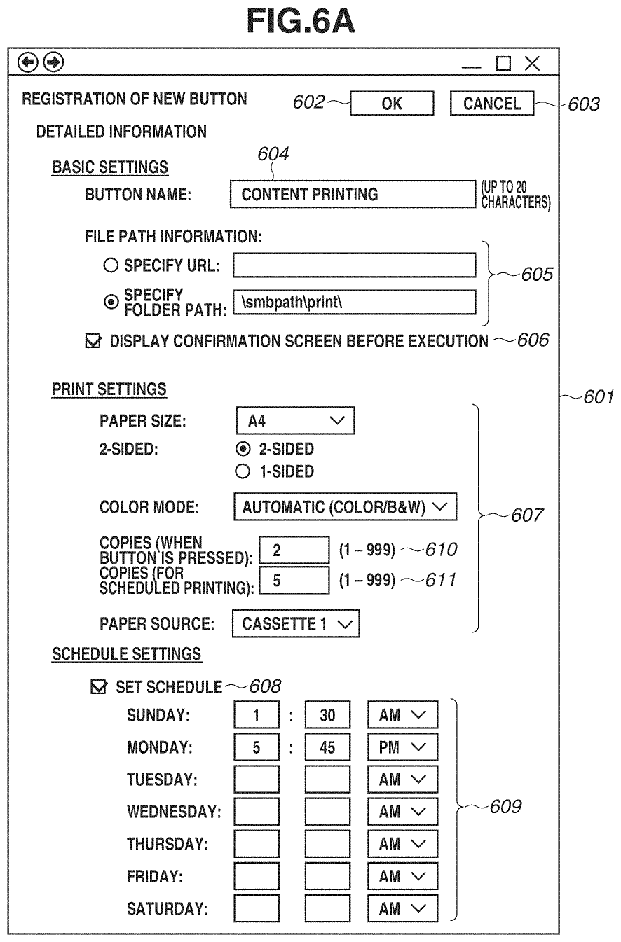

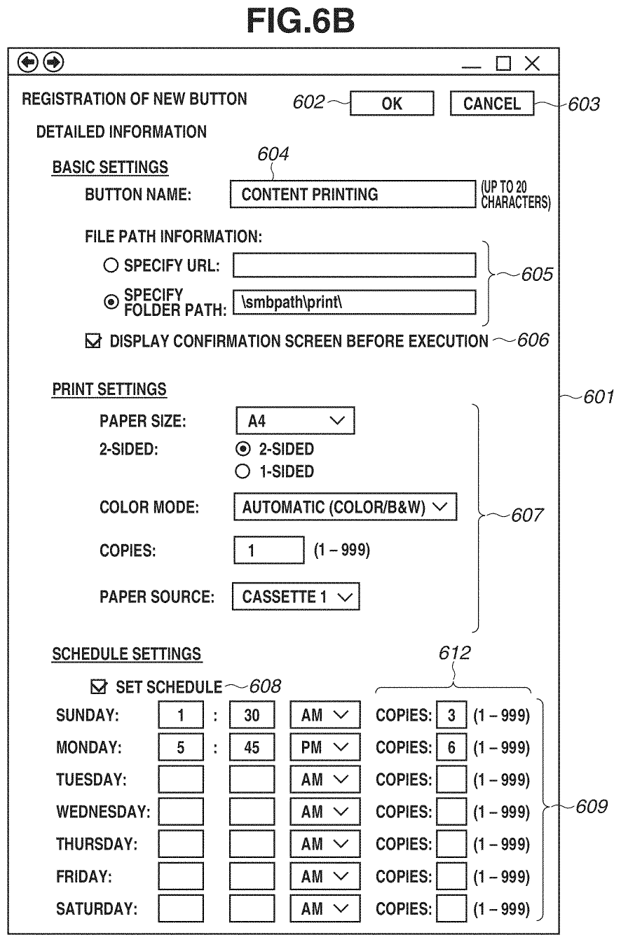

FIG. 6A illustrates an example of a setting screen 601 for the extension application 240. The setting screen 601 is displayed on a web browser operating on the host PC 402 connected to the image forming apparatus 401 via the Ethernet 404.

On the setting screen 601, Basic Settings include the following: Button Name 604, File Path Information 605, and Display Confirmation Screen before Execution 606. The Button Name 604 allows the user to set the name of the icon to be displayed on the main menu screen of the operation unit 112 of the image forming apparatus 401. The File Path Information 605 allows the user to set the address of the acquisition source of a printing target file. As the address of the file, URL information identifying the file may be specified, or path information for the folder in which the file is stored may be specified. The Display Confirmation Screen before Execution 606 allows the user to set whether to display an execution confirmation screen when the icon displayed on the main menu screen of the operation unit 112 of the image forming apparatus 401 is pressed.

The setting screen 601 also contains Schedule Settings for performing printing at a specified time on a specified day of the week. In the Schedule Settings, Set Schedule 608 allows the user to set whether to enable the schedule settings, and a Schedule Settings area 609 allows the user to set a printing execution time on each day of the week.

Furthermore, the setting screen 601 contains Print Settings 607 such as paper size, duplex printing, color mode, the number of copies, and paper source. Regarding the number of copies, Copies 610 and Copies 611 allow the user to set the number of copies separately for printing to be performed when the button is pressed and for printing to be performed based on the schedule settings. More specifically, the number of print copies can be set separately for the printing to be performed in response to the selection of the icon displayed on the main menu screen, and for the printing to be performed upon the arrival of the scheduled time set on the setting screen 601 illustrated in FIG. 6A.

If an OK button 602 is pressed on the setting screen 601, the icon associated with the settings made on the setting screen 601 is displayed on the main menu screen of the operation unit 112 of the image forming apparatus 401. If a Cancel button 603 is pressed on the setting screen 601, the settings made on the setting screen 601 are canceled, and the setting screen 601 is closed. Furthermore, if a plurality of different settings is made on the setting screen 601, a plurality of icons associated with the respective settings is displayed on the main menu screen of the operation unit 112 of the image forming apparatus 401.

FIG. 6B illustrates another example of the setting screen 601 for the extension application 240. In the example of FIG. 6A, the Copies 610 and the Copies 611 allow the user to set the number of copies separately for the printing triggered by pressing the button, and for the printing based on the schedule settings. In the example of FIG. 6B, at the time of schedule setting, Copies 612 allows the user to set the number of copies for each of different combinations of days and times of the week. The number of copies to be printed when the button is pressed can be set in the Print Settings 607.

The other settings on the setting screen 601 for the extension application 240 illustrated in FIG. 6B are the same as those illustrated in FIG. 6A. With the configuration of FIG. 6B, in a case where scheduled printing is used, the number of print copies can be set more finely than with the configuration of FIG. 6A.

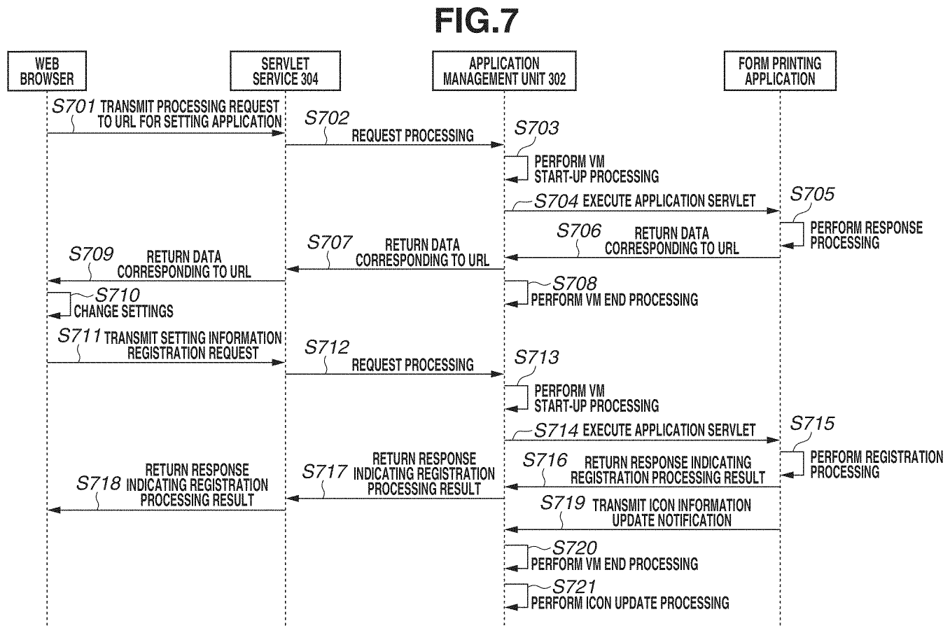

FIG. 7 illustrates a flow of an application setting procedure. With reference to FIG. 7, icon information generation processing for a form printing application that prints form image data registered by the user will be described as an example. Although the details of the processing differ from application to application, the basic processing is similar to steps illustrated in FIG. 7. The processing is performed by the CPU 101 based on a program stored in the storage 104.

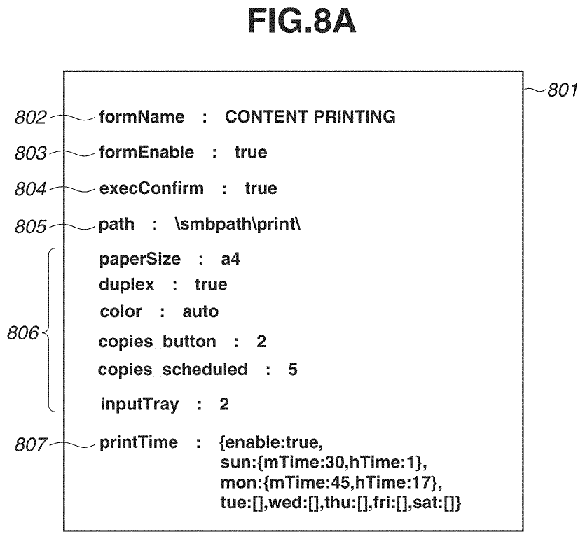

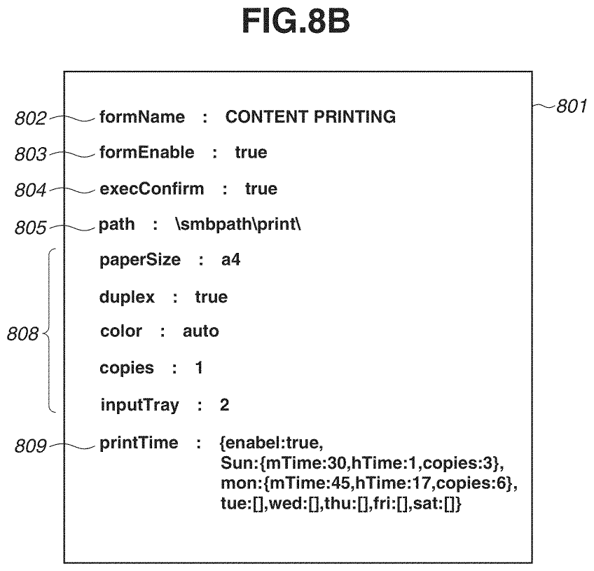

The application is to be set through the web browser operating on the host PC 402 and connecting to the image forming apparatus 401. First, in step S701, the web browser transmits information and a processing request to an URL for setting the application. In step S702, the servlet service 304 having received the processing request from the web browser requests the application management unit 302 to perform processing. The application management unit 302 identifies the application corresponding to the URL. In step S703, the application management unit 302 performs VM start-up processing for starting up a VM of the application. In step S704, the application management unit 302 executes an application servlet. At this time, the application management unit 302 notifies the application of the URL and the information transmitted from the web browser. In step S705, the application performs response processing in response to the request from the web browser. In this step, the application prepares a HyperText Markup Language (HTML) resource corresponding to the URL in order to return a response. The HTML resource describes an HTML form for referring to or setting information that is required for form printing processing and is illustrated in FIG. 8A or 8B. In step S706, the application returns a response with the prepared HTML resource, and the application ends. In step S707, the application management unit 302 simply returns the received response to the servlet service 304. In step S708, the application management unit 302 receives a notification about the end of the application and performs VM end processing. In step S709, the servlet service 304 simply returns the received response. In step S710, the user edits the screen displayed on the web browser, thereby changing the settings of the application. In this example, it is assumed that a printing form has been newly registered. In step S711, in response to an operation input by the user, the web browser transmits a setting information registration request to the servlet service 304. In step S712, the servlet service 304 requests the application management unit 302 to perform processing. Similarly to steps S703 to S708, in steps S713, S714, S715, and S716, the application management unit 302 identifies the application corresponding to the URL, executes the application servlet, processes the request from the web browser, and registers setting information. In step S717, the application management unit 302 simply returns a received response indicating a registration processing result, to the servlet service 304. In step S718, the servlet service 304 simply returns the received response. In step S719, the application transmits an icon information update notification to the application management unit 302 in order to register an icon for the registered form, and the application ends. In step S720, the application management unit 302 receives a notification about the end of the application and performs VM end processing. In step S721, the application management unit 302 performs icon update processing.

FIG. 8A illustrates an example of setting data 801 of the extension application 240. FIGS. 8A and 8B illustrate examples of the setting data 801, but the setting data 801 is not limited thereto.

The setting data 801 is written to the storage 104 when the OK button 602 is pressed on the setting screen 601 for the extension application 240.

The setting data 801 includes a setting value 802 indicating the button name, and a setting value 803 indicating whether to enable the settings (whether to display the icon on the operation unit 112 of the image forming apparatus 401). The setting data 801 also includes a setting value 804 indicating whether to display the confirmation screen before execution, and a setting value 805 indicating file path information for the printing target file. The values set in the Basic Settings (604, 605, and 606) on the setting screen 601 for the extension application 240 are reflected in the setting data 801.

The setting data 801 further includes setting values 806 for paper size, duple printing, color mode, the number of copies for the printing triggered by pressing the button, the number of copies for the scheduled printing, and paper source. The values set in the Print Settings (607, 610, and 611) on the setting screen 601 for the extension application 240 are reflected in the setting data 801.

The setting data 801 further includes setting values 807 indicating whether to enable the schedule settings and indicating the scheduled time on each day of the week. In the example of the setting data 801 illustrated in FIG. 8A, the scheduled time is set to 1:30 a.m. on Sunday and 5:45 p.m. on Monday, as set in the Schedule Settings area 609 on the setting screen 601 for the extension application 240.

FIG. 8B illustrates another example of the setting data 801 of the extension application 240. Regarding the number of copies, in the example of FIG. 8A, the number of copies to be printed by pressing the button and the number of copies to be printed based on the schedule settings are reflected in the setting values 806. In the example of FIG. 8B, the number of copies to be printed by pressing the button is reflected in setting values 808, and the number of copies to be printed on each day of the week based on the schedule settings is reflected in setting values 809, together with the scheduled time on each day of the week. FIG. 8B illustrates an example of the setting data 801 that is written in a case where three copies are scheduled to be printed at 1:30 a.m. on Sunday and six copies are scheduled to be printed at 5:45 p.m. on Monday.

The other setting values in the setting data 801 of the extension application 240 illustrated in FIG. 8B are the same as those described with reference to FIG. 8A.

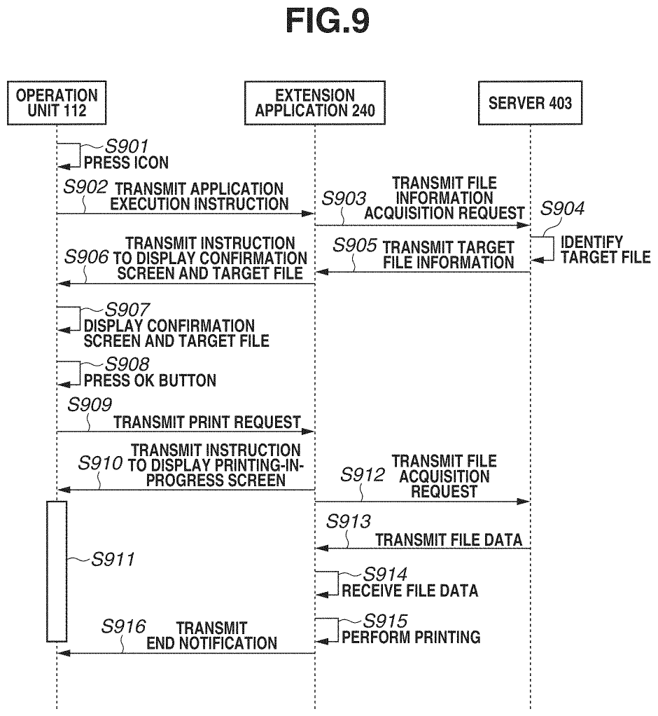

FIG. 9 illustrates a flow of a procedure for executing an application that is configured to, when the icon for the application is pressed, print a file based on path information associated with the icon. This application is referred to as a “content printing application”. In FIG. 9, the extension application 240 is the content printing application. The procedure is performed by the CPU 101 based on a program stored in the storage 104.

In step S901, if the icon for the extension application 240 on the operation unit 112 is pressed, then in step S902, the operation unit 112 transmits an application execution instruction to the extension application 240. In step S903, the extension application 240 having received the application execution instruction transmits a file information acquisition request to the server 403 based on the path information associated with the icon. When the server 403 receives the file information acquisition request from the extension application 240, then in step S904, the server 403 identifies a target file among files in the server 403. If a file is specified by the path information, the server 403 identifies the specified file as the target file. If a folder is specified by the path information, the server 403 identifies a plurality of files included in the specified folder as the target files. Next, in step S905, the server 403 transmits, to the extension application 240, information about the target file identified in step S904. When the extension application 240 receives the target file information from the server 403, then in step S906, the extension application 240 instructs the operation unit 112 to display the confirmation screen and the target file. When the operation unit 112 receives from the extension application 240 the instruction to display the confirmation screen and the target file, then in step S907, the operation unit 112 displays the confirmation screen including the print settings made on the setting screen 601 and the target file information. In step S907, the extension application 240 determines whether the printing is triggered by the selection of the icon or the arrival of the scheduled time. In this example, the extension application 240 determines that the printing is triggered by the selection of the icon. The extension application 240 displays, as the number of print copies, the value of “copies_button” that is a print setting associated with the selected icon and is described in the setting data 801 illustrated in FIG. 8A. In step S908, if an OK button is pressed on the confirmation screen displayed in step S907, then in step S909, the operation unit 112 transmits a print request to the extension application 240. When the extension application 240 receives the print request from the operation unit 112, then in step S910, the extension application 240 instructs the operation unit 112 to display a printing-in-progress screen. In step S912, the extension application 240 transmits a file acquisition request to the server 403. When the server 403 receives the file acquisition request from the extension application 240, then in step S913, the server 403 transmits data of the file identified in step S904 to the extension application 240. In step S914, the extension application 240 receives the data of the file from the server 403. In step S915, the extension application 240 prints the received data. In step S915, the extension application 240 displays, as the number of print copies, the value of “copies_button” that is a print setting associated with the selected icon and is described in the setting data 801 illustrated in FIG. 8A. If there is a plurality of target files, the processing in steps S914 and S915 is repeated a plurality of times. When the printing is completed in step S915, then in step S916, the extension application 240 notifies the operation unit 112 of the completion. In step S911, the operation unit 112 displays the printing-in-progress screen until the operation unit 112 receives the notification of the completion in step S916.

Next, processing for performing scheduled printing will be described with reference to FIG. 9. In the following description, only the differences from the processing performed when the user selects the icon displayed on the menu screen will be described. When the scheduled time set on the setting screen 601 of FIG. 6A or 6B arrives, processing in step S902 and the subsequent steps is performed. In processing corresponding to step S907, the extension application 240 determines whether the printing is triggered by the selection of the icon or the arrival of the scheduled time. In this example, the extension application 240 determines that the printing is triggered by the arrival of the scheduled time. The extension application 240 displays the number of print copies indicated by “copies_sheduled” illustrated in FIG. 8A. Also, in step S915, the extension application 240 performs printing based on the number of print copies indicated by “copies_sheduled” illustrated in FIG. 8A.

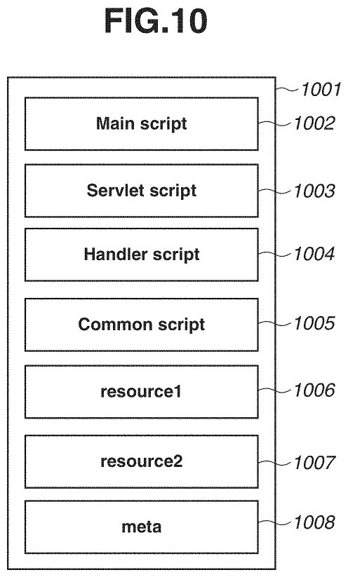

FIG. 10 illustrates a configuration of the installation data of the extension application 240.

An archive 1001 is a single piece of data into which all pieces of data included in the extension application 240 are combined. Files included in the extension application 240 can be roughly divided into three types. The first type is a script (each of scripts 1002 to 1005) describing the operation of the extension application 240 in a programming language. The second type is a resource file (each of resources 1006 and 1007) storing the image data and display message to be used by the extension application 240. The third type is a meta file 1008 indicating the application name. The above-described script includes the main script 1002, the servlet script 1003, the handler script 1004, and the common script 1005 that is shared by these scripts. The main script 1002 describes the operation to be performed when the icon displayed on the operation unit 112 is pressed. The servlet script 1003 is a script for performing the processing of the servlet service 304. The handler script 1004 is a script for performing the timer processing. When the extension application 240 is executed, only necessary scripts are loaded into a memory. Thus, it is possible to reduce unnecessary memory consumption.

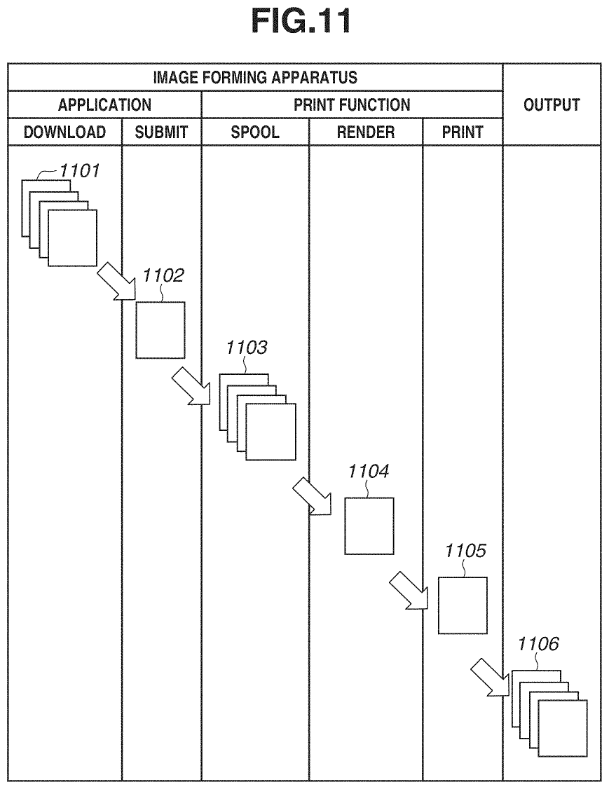

FIG. 11 illustrates how to process each page when printing a multi-page document. In process 1101, the extension application 240 downloads the multi-page document from the registered server 403. In process 1102, the extension application 240 sequentially submits pieces of data being downloaded, to the print function. In process 1103, the submitted data is spooled. In process 1104, the spooled data is rendered. In process 1105, the rendered data is printed. In process 1106, the printed data is output. When the submission of all the pieces of downloaded data is completed, the extension application 240 ends. The printing of the spooled data is continued even after the extension application 240 ends.

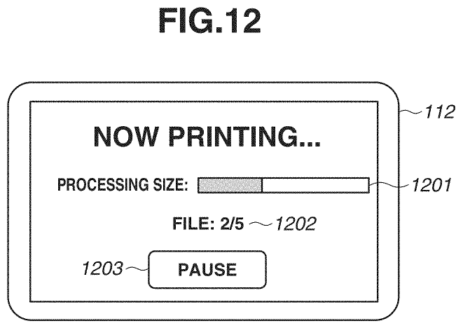

FIG. 12 illustrates an example of a screen displayed while the content printing application is being executed. The screen of FIG. 12 displays a submission progress status 1201 of the document currently being submitted. The screen of FIG. 12 also displays information 1202 indicating the number of files to print and the file number of the file currently being submitted. In this example, the total number of files to print is five, and the second file is currently being submitted. A Pause button 1203 illustrated in FIG. 12 is used to temporarily stop the submission of the job and end the application. For example, if the user wishes to perform scanning during the execution of the content printing application, the user presses the Pause button 1203 to stop the job and end the application, so that the user can use the image forming apparatus 401 for scanning.

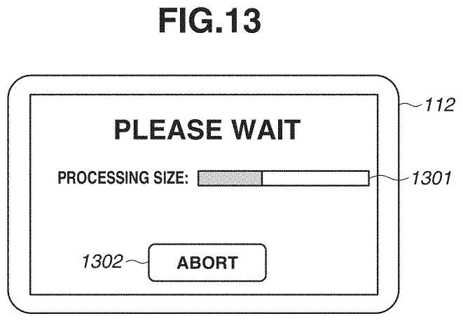

FIG. 13 illustrates an example of a screen displayed while pause processing is in progress after the Pause button 1203 illustrated in FIG. 12 is pressed. If the application is stopped during the submission of the data of the multi-page document (during process 1102 in FIG. 11), the application is stopped in a state where the document is printed halfway. This results in incomplete printing. To address this, if the Pause button 1203 is pressed, the application is not immediately stopped, and is ended after the submission of all the pieces of data of the downloaded file is completed. The screen of FIG. 13 displays a submission progress status 1301 of the document currently being submitted. Once the submission has been completed, the application ends. An Abort button 1302 illustrated in FIG. 13 is used to immediately stop the application in a case where it does not matter if an incomplete printing result is obtained. If the Abort button 1302 is pressed, the application is immediately stopped even during the submission of the data.

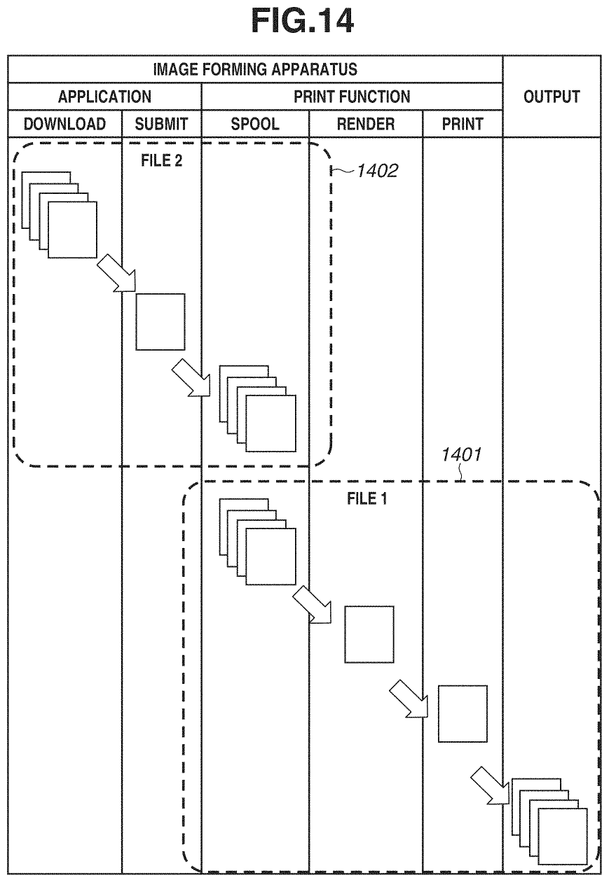

FIG. 14 illustrates how to process each page when printing two files (file 1 and file 2) in a folder. Referring to processes 1401 and 1402, the file 1 is submitted first. When the submission of the file 1 is completed, the file 2 is submitted. At this time, the file 1 is still being printed, and the file 2 is spooled and waits to be printed.

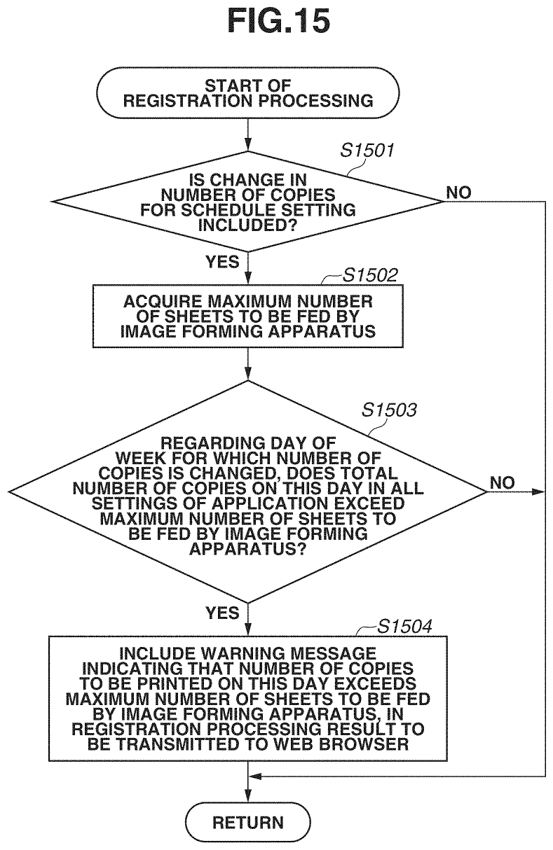

FIG. 15 is a flowchart illustrating the details of the setting information registration processing in step S715 in the application setting procedure of FIG. 7. In the following description, an example will be described where, in a case where a plurality of different settings is made on the setting screen 601 and in a case where the schedule settings are enabled in one or more of the plurality of settings, the application includes a warning message in the registration processing result response in step S716 depending on the contents of the settings.

More specifically, in step S1501, the application checks, at the time of the setting information registration processing in step S715, whether a change in the number of copies to be printed based on the schedule settings is included in the setting information. If a change in the number of copies to be printed based on the schedule settings is included (YES in step S1501), then in step S1502, the application acquires, from the storage 104, information regarding the maximum number of sheets to be fed by the image forming apparatus 401. Furthermore, in step S1503, regarding the day of the week for which the number of copies is changed, the application determines whether the total number of copies to be printed on the day of the week in all the settings of the application exceeds a threshold for the image forming apparatus 401. The threshold used in step S1503 is the maximum number of sheets to be fed by the image forming apparatus 401. The maximum number of sheets to be fed may be a value corresponding to a single cassette of the image forming apparatus 401, or may be the sum of values corresponding to all cassettes included in the image forming apparatus 401.

If the application determines in step S1503 that the total number of copies exceeds the threshold (YES in step S1503), then in step S1504, the application includes a warning message indicating that the number of copies to be printed on the day of the week exceeds the maximum number of sheets to be fed by the image forming apparatus 401, in the registration processing result response to be transmitted to the web browser in step S716. If the application determines in step S1503 that the total number of copies does not exceed the threshold (NO in step S1503), the processing illustrated in FIG. 15 ends.

In step S1503, the number of print copies set in the schedule settings is compared with the threshold. This is because at least one sheet is used to print each copy. Alternatively, the number of sheets to be used when scheduled printing is actually performed may be obtained based on the print settings made on the setting screen 601 illustrated in FIG. 6B, and compared with the threshold.

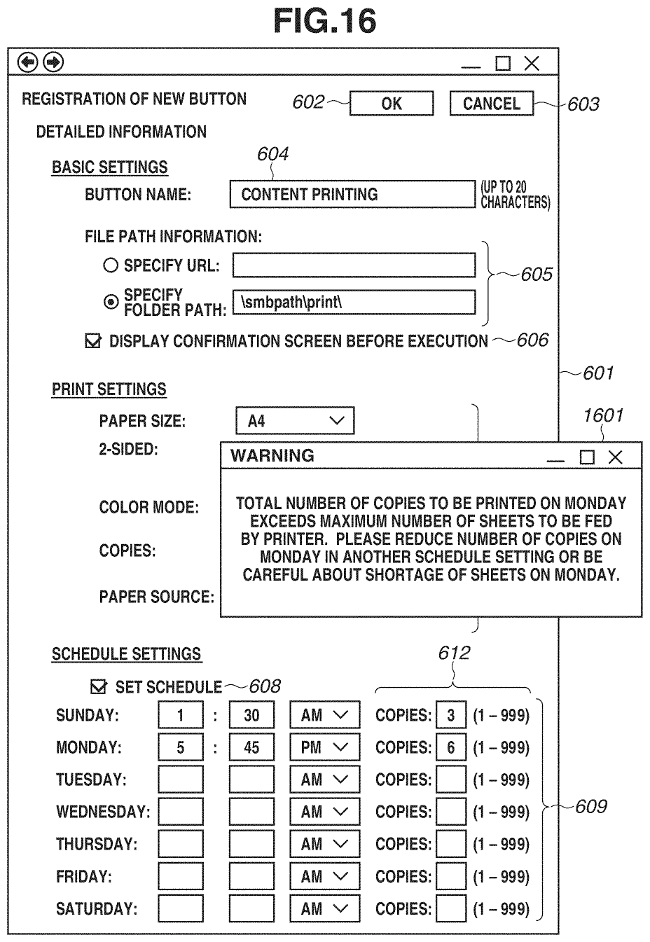

FIG. 16 illustrates an example of a warning message 1601 popped up on the setting screen 601. In FIG. 16, the warning message 1601 indicating that the number of copies to be printed on a specific day (Monday) of the week exceeds the maximum number of sheets to be fed by the image forming apparatus 401 pops up on the setting screen 601. The warning message 1601 warns that the user should reduce the number of copies to be printed on the day of the week or should be careful about running-out of sheets on the day of the week. The warning message 1601 is merely an example, and the message to be output is not limited thereto as long as the message indicates a possibility that sheets may need to be replenished. Displaying the above-described message can notify the user that there is a possibility of running-out of sheets due to the execution of printing based on the schedule settings.

The above-described exemplary embodiment of the present disclosure can also be implemented by supplying software (a program) for implementing at least one function according to the above-described exemplary embodiment to a system or an apparatus via a network or various storage media, and causing a computer (e.g., CPU, microprocessor unit (MPU)) of the system or the apparatus to read and execute the program code. In this case, the computer program and a storage medium storing the computer program constitute an exemplary embodiment of the present disclosure.

In a case where the user performs schedule settings, the image forming apparatus according to the above-described exemplary embodiment allows the user to set the number of print copies separately for the printing triggered by pressing the button on the operation screen and for the printing based on the schedule settings.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-126643, filed Jul. 27, 2020, which is hereby incorporated by reference herein in its entirety.

What is claimed is:

1. An image forming apparatus comprising:
a registration unit configured to register an address at which image data to be printed is stored;
an acquisition unit configured to access the registered address to acquire the image data;
a control unit configured to perform print processing based on the acquired image data;
a first setting unit configured to set a number of copies to be printed when printing based on the acquired image data is performed in response to an instruction received from a user through an operation unit;
a reception unit configured to receive a specified time of day; and
a second setting unit configured to set a number of copies to be printed when the printing based on the acquired image data is performed upon arrival of the time received by the reception unit.

2. The image forming apparatus according to claim 1, further comprising a printing unit configured to, in response to the instruction, perform the printing based on the acquired image data according to the number of copies set by the first setting unit, and to, upon the arrival of the specified time, perform the printing based on the acquired image data according to the number of copies set by the second setting unit.

3. The image forming apparatus according to claim 1,
wherein the reception unit receives a plurality of specified times of day, and
wherein the second setting unit sets numbers of copies to be printed at the respective plurality of times received by the reception unit.

4. The image forming apparatus according to claim 3, further comprising a display unit configured to display a message regarding replenishment of sheets to the image forming apparatus, based on the numbers of copies set by the second setting unit.

5. The image forming apparatus according to claim 4, further comprising a determination unit configured to determine whether a total number of sheets for use in the printing based on the acquired image data exceeds a threshold, wherein the total number of sheets is obtained based on the numbers of copies set by the second setting unit,
wherein the display unit displays the message based on a result of the determination by the determination unit.

6. The image forming apparatus according to claim 5, wherein the message notifies the user that there is a possibility of running-out of sheets.

7. The image forming apparatus according to claim 1, wherein, in a case where the number of copies is not set by the second setting unit, the printing based on the acquired image data is performed upon the arrival of the specified time, according to the number of copies set by the first setting unit.

8. The image forming apparatus according to claim 1, wherein the second setting unit sets the number of copies for each day of a week.

9. The image forming apparatus according to claim 1, wherein the address is a path to a file, or a Uniform Resource Locator (URL) of the file.

10. A method for controlling an image forming apparatus, the method comprising:
registering an address at which image data to be printed is stored;
accessing the registered address to acquire the image data;
setting, as a first setting, a number of copies to be printed when printing based on the acquired image data is performed in response to an instruction received from a user through an operation unit;
receiving a specified time of day;
setting, as a second setting, a number of copies to be printed when the printing based on the acquired image data is performed upon arrival of the received time; and
performing the printing based on the acquired image data according to the number of copies set as the first setting or the second setting.

11. A non-transitory computer-readable storage medium storing a program for causing a computer to execute a method for controlling an image forming apparatus, the method comprising:
registering an address at which image data to be printed is stored;
accessing the registered address to acquire the image data;
setting, as a first setting, a number of copies to be printed when printing based on the acquired image data is performed in response to an instruction received from a user through an operation unit;
receiving a specified time of day;
setting, as a second setting, a number of copies to be printed when the printing based on the acquired image data is performed upon arrival of the received time; and
performing the printing based on the acquired image data according to the number of copies set as the first setting or the second setting.
